(19) United States
(12) Patent Application Publication
(10) Pub. No.: US 2017/0234154 A1
(43) Pub. Date: Aug. 17, 2017

(54) Turbine stator vane with closed-loop sequential impingement cooling insert

(71) Applicant: James P Downs, Hobe Sound, FL (US)

(72) Inventor: James P Downs, Hobe Sound, FL (US)

(21) Appl. No.: 15/253,210

(22) Filed: Aug. 31, 2016

Related U.S. Application Data
(60) Provisional application No. 62/295,747, filed on Feb. 16, 2016.
(60) Provisional application No. 62/296,820, filed on Feb. 18, 2016.

(51) Int. Cl. F01D 25/12; F01D 9/04

(52) U.S. Cl. CPC F01D 25/12; F01D 9/041; F05D 2260/201; F05D 2250/185; F05D 2240/12; F05D 2220/76

(57) ABSTRACT

A turbine stator vane with a closed loop sequential impingement cooling circuit with an impingement cooling insert that includes a three-pass serpentine flow cooling circuit, where each leg of the circuit includes a cooling air supply channel and a return channel with rows of impingement cooling holes and rows of return openings connecting them together. Turn channels are located at the outer diameter and the inner diameter of the vane to direct cooling air from the first leg and into the second and third legs in series. Impingement holes are formed on impingement surfaces that alternate with return slots formed in the insert.

### CROSS-REFERENCE TO RELATED APPLICATIONS

This application claims the benefit to U.S. Provisional Application 62/295,747 filed on Feb. 16, 2016 and entitled TURBINE STATOR VANE WITH MULTIPLE OD PRESSURE FEEDS and U.S. Provisional Application 62/296,920 filed on Feb. 18, 2016 and entitled TURBINE STATOR VANE WITH SPENT COOLING AIR RETURN.

### GOVERNMENT LICENSE RIGHTS

This invention was made with Government support under contract number DE-FE0023975 awarded by Department of Energy. The Government has certain rights in the invention.

### BACKGROUND OF THE INVENTION

Field of the Invention

The present invention relates generally to cooled turbine components and specifically to semi-closed-loop internally cooled turbine stator vanes that return spent cooling flow to the combustion process to enhance power output and thermodynamic efficiency.

Description of the Related Art Including Information Disclosed Under 37 CFR 1.97 and 1.98

The current state-of-the-art in gas turbine vane OD (Outer Diameter) multi-cooling feed is shown in the prior art U.S. Pat. No. 8,961,108 issued to Bergman et al. on Feb. 24, 2015. In this approach, the cooling system contains two cooling flow passageways through the mounting hook, that are not in fluid communication with each other, fed by the same first high pressure plenum. A second plenum supplies the aft cavities of the stator with an intermediate pressure. High pressure and intermediate pressure flows are extracted from the flow of the compressed air from the compressor located on the same centerline. As shown, the flow is provided through plenums at the BOAS (Blade Outer Air Seal) and the vane OD platform. The flow is then routed and split through the mounting hooks (passageways 1 & 2, fed from plenum 1) and direct into the aft cooling passages for cooling flow passageway 3 (F3, fed from plenum 2).

In this current state-of-the-art multi-feed cooling technique, the first plenum supplied by the compressor high pressure air feeds the first passage and second passages. The first passage supplies the compressor bleed high pressure cooling air to the adjacent BOAS. The second passage is routed through the mounting hook and supplies the same (first) plenum cooling air to the vane OD and the airfoil leading edge. The second plenum, supplied by the compressor from a higher stage (lower pressure) then feeds the third passage from the vane OD into the trailing edge cooling channels of the airfoil. The second passage cooling air then exits the leading edge through film holes and the third passage cooling air exits out the trailing edge to mix with the hot gas stream passing through the turbine. The mixing of spent cooling air with the hot gas stream results in performance and power losses to the machine. Higher pressure air also introduces leakages at the vane OD platform, which in this technique were reduced with the addition of multiple seals, shown in the Bergman patent U.S. Pat. No. 8,961,108. However, with high pressure or over-pressurized supply air, these seals can contribute to large leaks of the cooling air into the gas path.

Introduction of over-pressurized cooling air recirculated through turbine stator vane would introduce a significant amount of leakage flow at the OD and ID (Inner Diameter) if used for cooling the surrounding hooks, pre-swirler or U-rings, downstream ring segments, and the back side of vane platforms. A second lower-pressure source is introduced and an updated configuration to fit multiple feed plumbing into the vane OD developed here to address this issue.

In a gas turbine engine, the prior art gas turbine stator vane cooling shown in U.S. Pat. No. 5,383,766 issued to Przirembel on Jan. 24, 1995 shows cooling accomplished by extracting relatively cool air from the compressor and delivering it to the turbine to be used as coolant. While the remainder of the compressor discharge air continues to flow into the combustor, to be mixed with fuel and to be burned to provide the needed hot working fluid, which subsequently flows around the turbine vane airfoil, the cooling air is supplied separately to the vane cooling system. A plurality of impingement inserts are installed inside the vane airfoil. Cooling air is supplied to the inside of the inserts and is allowed to flow through a plurality of holes in the inserts to impinge upon the inside of the vane airfoil to create an enhanced (impingement) heat transfer effect. In this example, the cooling air which flows through the impingement insert 28 then flows through film cooling holes at the leading edge, and forward pressure and suction sides to further cool the part by convection heat transfer within the holes and also by creating a film cooling effect via a layer of cooler air that flows over the surface of the airfoil. Cooling air which entered impingement insert 30 is also discharged from film cooling holes located along the aft pressure side surface of the airfoil and also from the trailing edge cooling passages.

In the prior art Przirembel cooling design, all of the cooling air is ejected from the airfoil and mixes with the hot gas which is flowing around the airfoil. Such mixing of spent cooling air results in performance and power losses to the engine. For example, the ability of the cooling air, whose pressure has been increased in the compressor, to provide useful work in the turbine is greatly reduced because no heat has been added to it in the combustor. Further, the ejection of spent cooling air into the primary hot gas flow reduces turbine efficiency via mixing losses because the cooling air, which enters the primary hot gas flow with relatively low velocity, slows the hot gases as the two streams intersect and achieve a balance of momentum. Finally, the power of the engine is reduced as the temperature of the hot gases are diluted with the cooler cooling air.

In another prior art stator vane cooling design, a conventional open-loop air cooled turbine nozzle causes the hot gas temperature to be decreased by 280° F. (155° C.) as a result of the mixing of cold spent cooling air with the hot gases flowing around the airfoil.

In another prior art cooling design, a closed-loop steam cooling system replaces the open loop air cooled system where a temperature reduction of the hot gas is reduced to 80° F. (44° C.). While this illustrates the potential benefit of closed loop cooling, this steam cooled system is rather complicated and has several technical challenges that are overcome by the present invention. To give a few examples: 1) heat rejected from the turbine vanes via the steam coolant is returned to a low energy point of the thermodynamic system, thereby limiting the efficiency and power output of the machine; 2) use of steam cooling requires a separate steam system to be implemented, maintained and controlled in an operational condition; 3) the adverse effects of steam on the metallurgy of the materials used to construct the turbine components must be overcome; and 4) any loss of steam through leaks must be replaced with makeup water that may be expensive or unavailable depending on the installation location.

### BRIEF SUMMARY OF THE INVENTION

The present invention relates generally to cooled turbine components and specifically to turbine stator vanes fed with multiple pressures including recirculated cooling air pressurized over compressor exit, to reduce leakages while enhancing power output and thermodynamic efficiency. A higher pressure cooling air is passed through a stator vane in a closed loop cooling circuit in which the spent cooling air is then discharged into the combustor. The higher pressure cooling air is required to provide both cooling for the stator vane and have enough pressure to flow into the combustor. A lower pressure cooling air is used to provide cooling for the endwalls and hooks of the stator vane, where this spent cooling air is then discharged into the hot gas stream.

A turbine stator vane with sequential impingement cooling and where spent cooling air is delivered to the combustor to be burned with fuel instead of discharged into the turbine hot gas path. The turbine stator vane is for use in a twin spool gas turbine engine in which the two spools are capable of operating independently and where a closed loop cooling circuit for both the rotor blades and the stator vanes are used in which all spent cooling air is passed into the combustor.

### BRIEF DESCRIPTION OF THE SEVERAL VIEWS OF THE DRAWINGS

FIG. 1 shows a cross section top view of a closed loop cooling circuit for a turbine stator vane cooling circuit of the present invention

FIG. 2 shows a cross section view of a stator vane in a turbine with the cooling air inlet and outlet connections of the cooling circuit of the present invention.

FIG. 3 shows a top view of a vane doublet with the cooling circuit of the present invention.

FIG. 4 shows a top view of a vane singlet with the cooling circuit of the present invention.

FIG. 5 shows a combined cycle power plant with an industrial gas turbine engine of the present invention.

FIG. 6 shows another embodiment combined cycle power plant with an industrial gas turbine engine of the present invention in which the turbine stator vane is cooled.

FIG. 7 shows another embodiment combined cycle power plant with an industrial gas turbine engine of the present invention in which the turbine stator vane is cooled.

FIG. 8 shows a turbine stator vane with two sequential impingement cooling inserts of the present invention.

FIG. 9 shows the turbine stator vane of FIG. 8 without the two sequential impingement cooling inserts.

FIG. 10 shows the two sequential impingement cooling inserts from a suction side of the present invention.

FIG. 11 shows a close-up view of a section of the forward sequential impingement insert with return openings of the present invention.

FIG. 12 shows a close-up view of a section of the aft sequential impingement insert with return openings of the present invention.

FIG. 13 shows the two sequential impingement cooling inserts of the present invention from the pressure side.

FIG. 14 shows the two sequential impingement cooling inserts of the present invention from the pressure side.

FIG. 15 shows the turbine stator vane outer endwall with a cover plate enclosing the two sequential impingement cooling inserts of the present invention.

FIG. 16 shows the turbine stator vane inner endwall with a cover plate enclosing the two sequential impingement cooling inserts of the present invention.

FIG. 17 shows the turbine stator vane without the two sequential impingement cooling inserts with the cooling air supply and discharge openings and coolant connection openings in the insert cavities of the present invention.

FIG. 18 shows a top view of the stator vane with the two sequential cooling inserts and the flow direction from the two cooling air supply and discharge openings of the present invention.

FIG. 19 shows a cross section side view of the turbine stator vane with the two sequential cooling inserts and flow paths of the present invention.

### DETAILED DESCRIPTION OF THE INVENTION

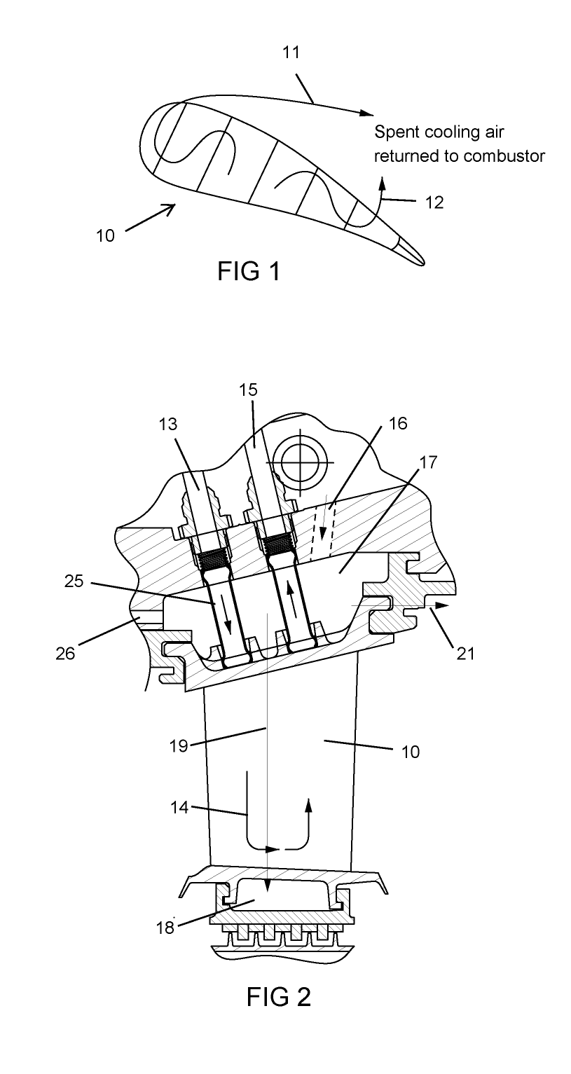

To solve problems of the current state-of-the-art and other methods utilizing pressures higher than compressor exit (over-pressurized cooling supply air) recirculated, the present invention proposes the use of multiple feed and extraction tubes consisting of supplies from over-pressurized air and compressor bled flows, organized at the vane Outer Diameter (OD). The present invention is shown in conceptual form in the FIGS. 1-4, but not limited to the shown orientation.

FIG. 1 shows a stator vane 10 with a first cooling circuit 11 for a forward section of the airfoil and a second cooling circuit 12 for an aft section of the airfoil. Both cooling circuits 11 and 12 are higher pressure cooling air that first provides cooling for the stator vane 10 and second has enough remaining pressure to be discharged into the combustor along with the compressed air discharged from the compressor. FIG. 1 shows two high pressure cooling circuits, but could have only one high pressure cooling circuit where the spent cooling air is discharged into the combustor.

FIG. 2 shows a side view of a stator vane with cooling circuits according to the present invention where a higher pressure cooling air is used along with a lower pressure cooling air to provide cooling for the airfoil as well as the endwalls and the hooks of the stator vane. A higher pressure cooling air flows into the higher pressure cooling air feed tube 13, which then flows thru an internal airfoil cooling circuit 14 to provide cooling for the airfoil of the stator vane 10. The higher pressure spent cooling air then flows out from the airfoil through exit tube 15 where the spent cooling air is discharged into the combustor. This higher pressure cooling air can be merged with compressor outlet air in a diffuser positioned between the compressor outlet and the combustor inlet. The higher pressure cooling air circuit is a closed loop cooling circuit in which none of the cooling air is discharged out film holes into the hot gas stream passing thru the turbine. In another embodiment of the present invention, some of the stator vane cooling air can be used to provide cooling to the trailing edge and even the leading edge of the airfoil that is discharged into the hot gas stream in order to adequately cool these sections of the airfoil.

The OD endwall and ID endwall and hooks of the stator vane 10 is cooled using lower pressure cooling air such as that bleed off from the compressor. A lower pressure cooling air feed tube 16 delivers lower pressure cooling air to the vane 10 to provide cooling for the OD endwall cavity 17 and the ID endwall cavity 18 and surrounding areas thru a lower pressure cooling air passage 19 within the airfoil of the vane 10. The lower pressure cooling air can be discharged into the hot gas stream thru exit 21 and other exits including trailing edge exit holes or other exit holes in the airfoil. By using lower pressure cooling air instead of the high pressure cooling air in places that discharge the spent cooling air from the vane and into the hot gas stream, higher pressure seals are not required. If the higher pressure cooling air was used in the places where the lower pressure cooling air is used, the higher pressure cooling air would produce a large cooling air leakage thru the seals and into the hot gas stream. Thus, less higher pressure cooling air would be available for discharge into the combustor after cooling of the stator vane and surrounding areas.

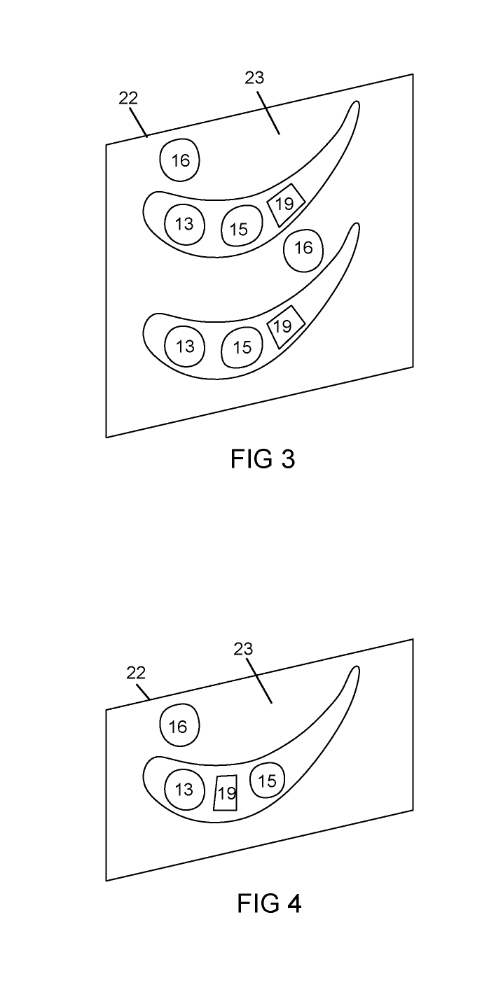

FIG. 3 shows a doublet stator vane segment in which the vane segment has two airfoils extending between the endwall cavities. FIG. 3 shows a turbine vane carrier 22 with an OD platform 23, a lower pressure feed tube 16 and a higher pressure feed tube 13. The higher pressure exit tube 15 and the lower pressure cooling passage 19 formed within the airfoil is shown in FIG. 3 for the two airfoils. A second lower pressure feed tube 16 is shown in the OD endwall. FIG. 4 shows a similar arrangement for a single airfoil stator vane segment.

The higher pressure cooling air circuit and the lower pressure cooling air circuit are separate cooling circuits and not in fluid communication to reduce any leakages. The feed and exit tubes 13 and 15 in FIG. 2 prevent the higher pressure cooling air from leaking into the lower pressure cooling air of the OD endwall cavity 17. The lower pressure cooling air feed tube 16 is formed as a hole in the turbine vane carrier to the OD cavity. The lower pressure feed tube 16 can also be sourced to adjacent ring segments through mounting hooks on the vane.

The lower pressure cooling air source also feeds the ID cavity 18 cooling through a bypass cooling channel 19 within the vane. A second form fitted tube is connected directly to the vane OD cooling exit passage 17, following a closed loop design for the over-pressurized air. Utilizing this closed loop design in conjunction with the multi-feed multi-pressure supply allows higher thermal efficiency, higher power output, but minimal leakage of over-pressurized cooling air into the gas-path.

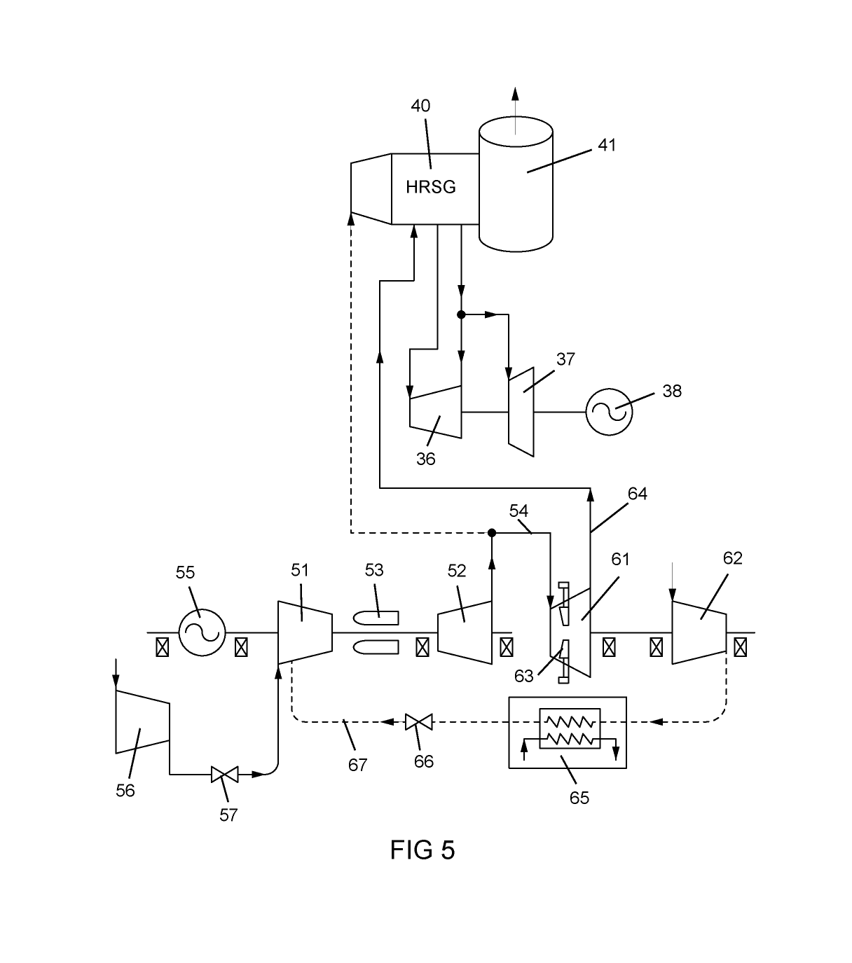

FIG. 5 shows one embodiment of a combined cycle power plant of the present invention which makes use of the turbine stator vane cooling circuit of FIGS. 1-4. The power plant includes a high spool with a high pressure compressor (HPC) 51 driven by a high pressure turbine (HPT) 52 from a hot gas stream produced in a combustor 53 where the high spool drives an electric generator 55. A low spool or turbocharger includes a low pressure compressor (LPC) 62 driven by a low pressure turbine (LPT) 61 that is driven by turbine exhaust from the HPT 52. The LPC includes a variable inlet guide vane assembly to regulate the speed of the low spool. The LPC 62 delivers compressed air to the HPC 51. An intercooler 65 in compressed air line 67 cools the compressed air from the LPC 62. Regulator valve 66 is in the compressed air line 67. A boost compressor 56 with valve 57 can be used to deliver low pressure air to the inlet of the HPC 51 in certain situations.

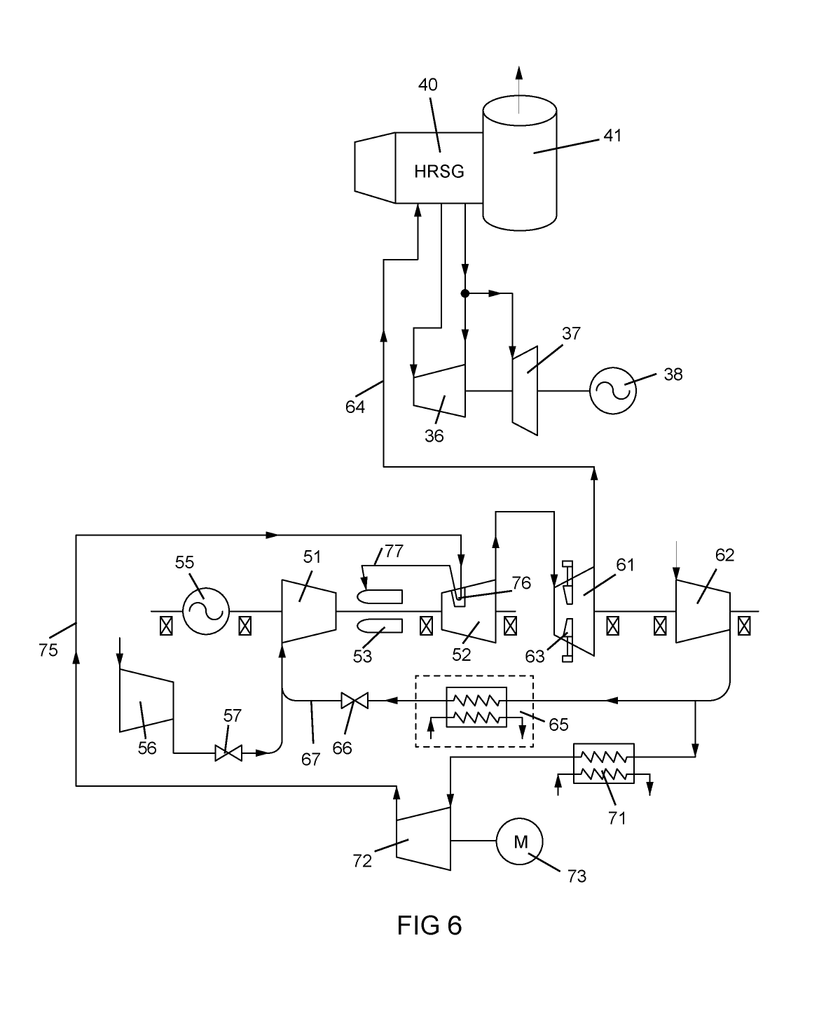

FIG. 6 shows another version of the combined cycle power plant of the present invention in which the turbine stator vanes are cooled using compressed air from the compressed air line 67. Some of the compressed air from the line 67 is diverted into a second intercooler 71 and then further compressed by a boost compressor 72 driven by a motor 73 to a higher pressure than the outlet pressure of the HPC 51 so that the turbine stator vanes 76 can be cooled and the spent cooling air can be discharged into the combustor 53 through spent cooling air line 77. The higher pressure cooling air feed tube 13 and exit tube 15 of the vane in FIG. 2 would be lines 75 and 77 in FIG. 6. The lower pressure cooling air delivered to the lower pressure cooling air feed tube 16 would be discharged from the endwall cavities and into the hot gas stream passing through the turbine 52.

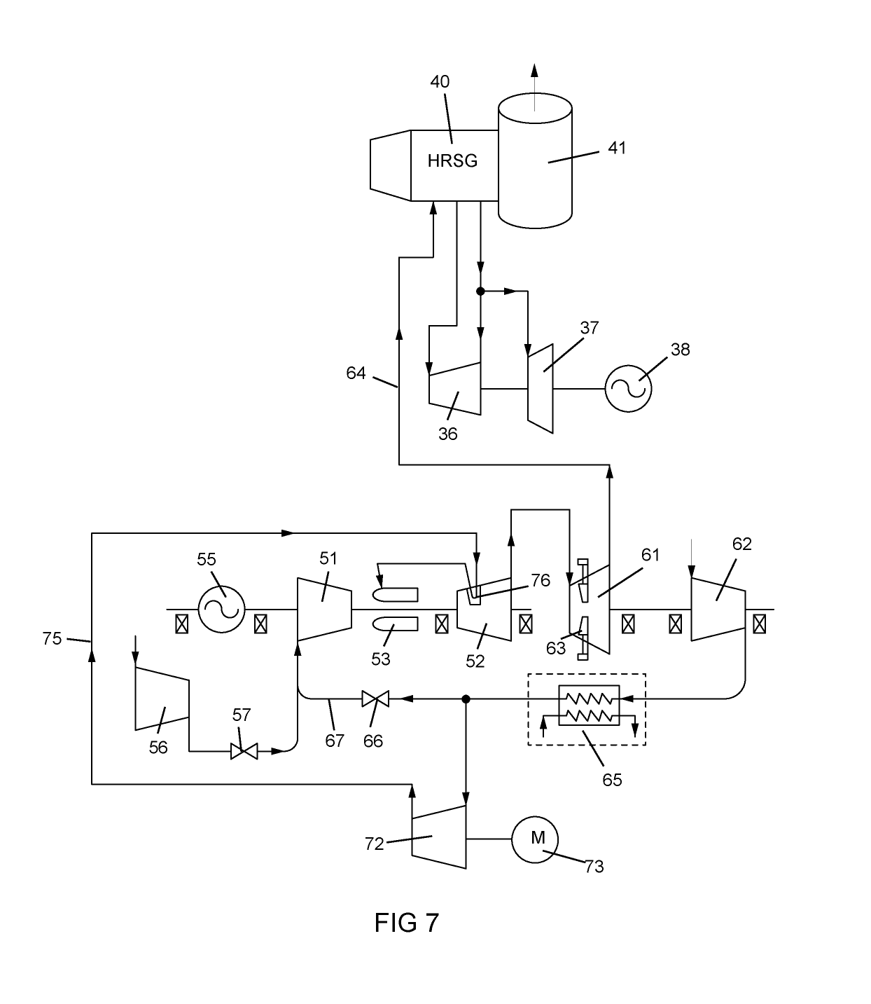

FIG. 7 shows another embodiment of the combined cycle power plant similar to the FIG. 6 embodiment in which only one intercooler 65 is used to cool both the compressed air going to the HPC 51 and to the boost compressor 72.

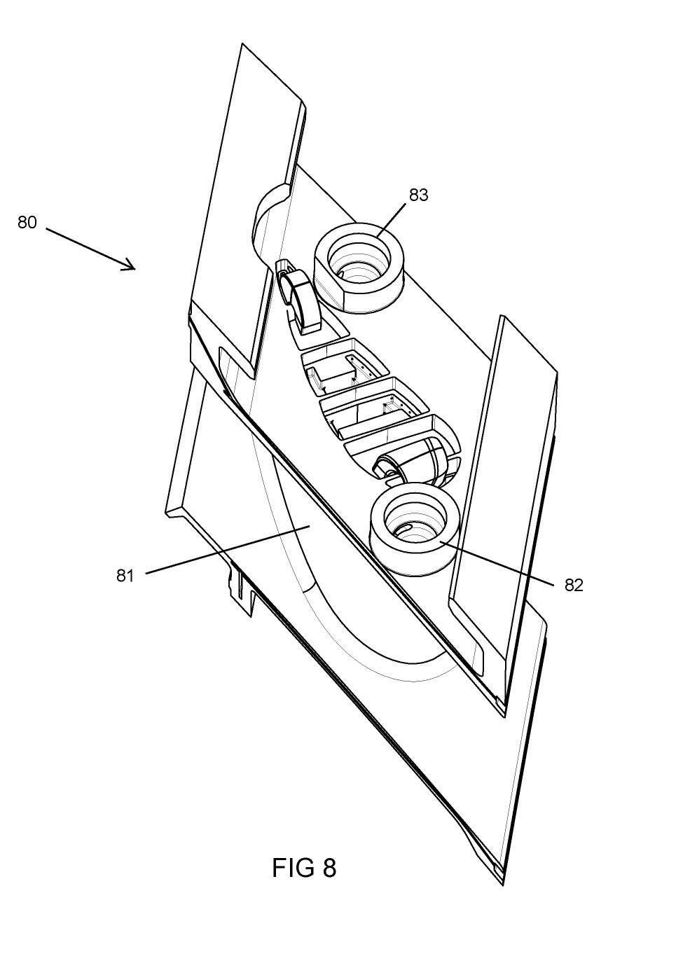

FIGS. 8 through 19 show various features of the turbine stator vane with the closed loop cooling circuit for use in the industrial gas turbine engine of the present invention in which the cooling air used for the stator vane is discharged into the combustor instead of into the hot gas stream in the turbine. FIG. 2 shows the turbine stator vane with inlet and outlet tubes 13 and 15 for the supply and return of the cooling air in the vane. FIGS. 8 through 19 show various details of the stator vane cooling circuit that includes two sequential impingement cooling inserts.

In FIG. 8, the stator vane 80 includes an airfoil 81 extending between an inner endwall and an outer endwall, and a cooling air inlet 82 and a cooling air outlet 83. Two sequential impingement cooling inserts are shown in the cavities of the vane airfoil 81.

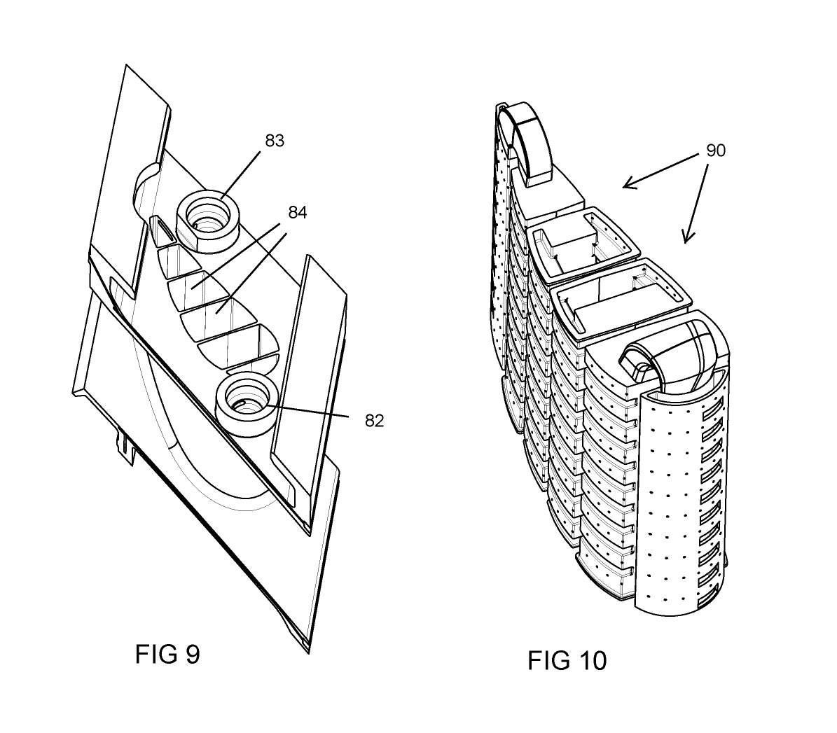

FIG. 9 shows the vane airfoil without the two inserts. The airfoil includes a number of internal cooling air passages 84 in which the two inserts are located. FIG. 10 shows the two sequential impingement cooling inserts 90 as an assembly outside of the airfoil.

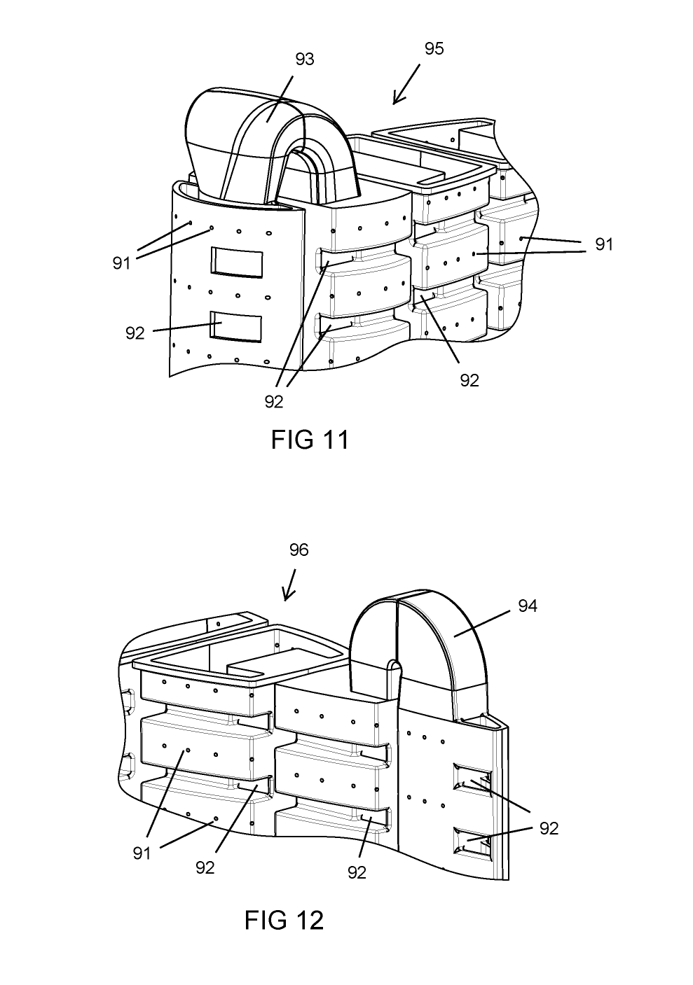

FIG. 11 shows a detailed view of the leading edge (forward) cooling insert 95 with a leading edge coolant turn passage 93, multiple rows of impingement cooling holes 91 extending in a chordwise direction of the airfoil, and cooling air return openings 92 extending in a spanwise direction of the airfoil. FIG. 12 shows a detailed view of a section of the trailing edge (aft) cooling insert 96 with a trailing edge turn passage 94 as well as multiple rows of impingement cooling holes 91 and cooling air return openings 92. Each of the two impingement cooling inserts 95 and 96 is formed with alternating outer surfaces in which the impingement holes 91 are located and inner surfaces that form spent impingement cooling air return channels in which the spent impingement cooling air is collected. Inside these inner surfaces are located cooling air return openings 92 in which the spent impingement cooling air flows through and into spanwise extending channels to channel the cooling air to the next location.

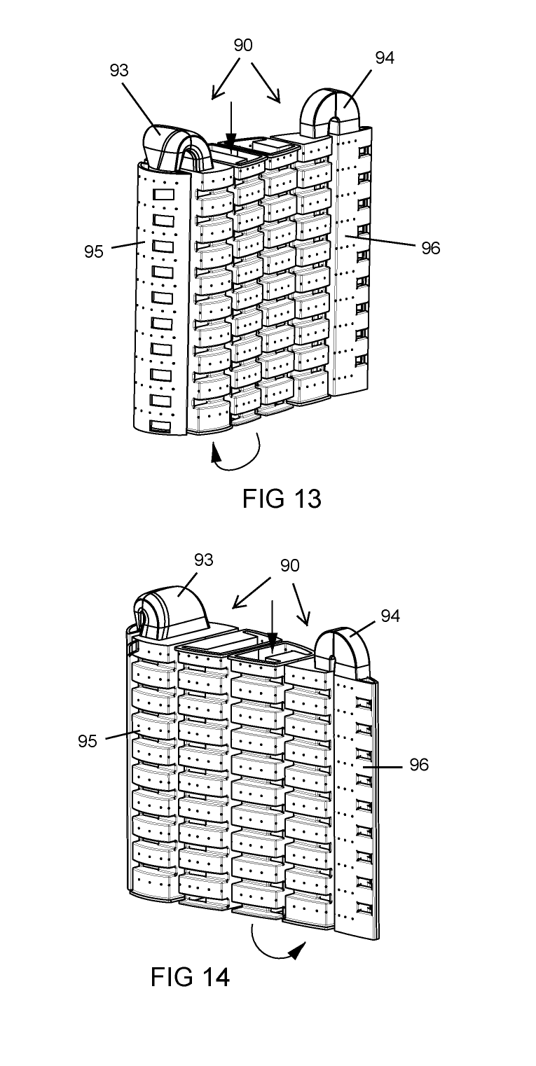

FIG. 13 shows the two (forward and aft) impingement cooling inserts 95 and 96 from the front of the pressure wall side with the leading edge coolant return passage 93 and the trailing edge coolant return passage 94. FIG. 14 shows the forward and aft insert assembly 90 from the rear of the pressure wall side. The arrow on the top side pointed down shows the coolant supply direction. The coolant flows into the channel in a middle section of the airfoil and flows downward and out the impingement holes, then is collected in the return channels and flows through the return openings and into the channel that flows upward. The two curved arrows at the bottom of FIGS. 13 and 14 represent this coolant turn. As the coolant flows upward, the cooling air flows out through the impingement holes 91 and then into the return channels and through the return openings 92 and into the channel that flows upward. The cooling air then flows through the two turn passages 93 and 94, and then flows down again in the last channels and through impingement holes 91 along the leading edge and trailing edge of the airfoil. The suction side of the inserts also includes these rows of impingement cooling holes 91 and the return openings 92 to provide impingement cooling to the suction side wall of the airfoil as well.

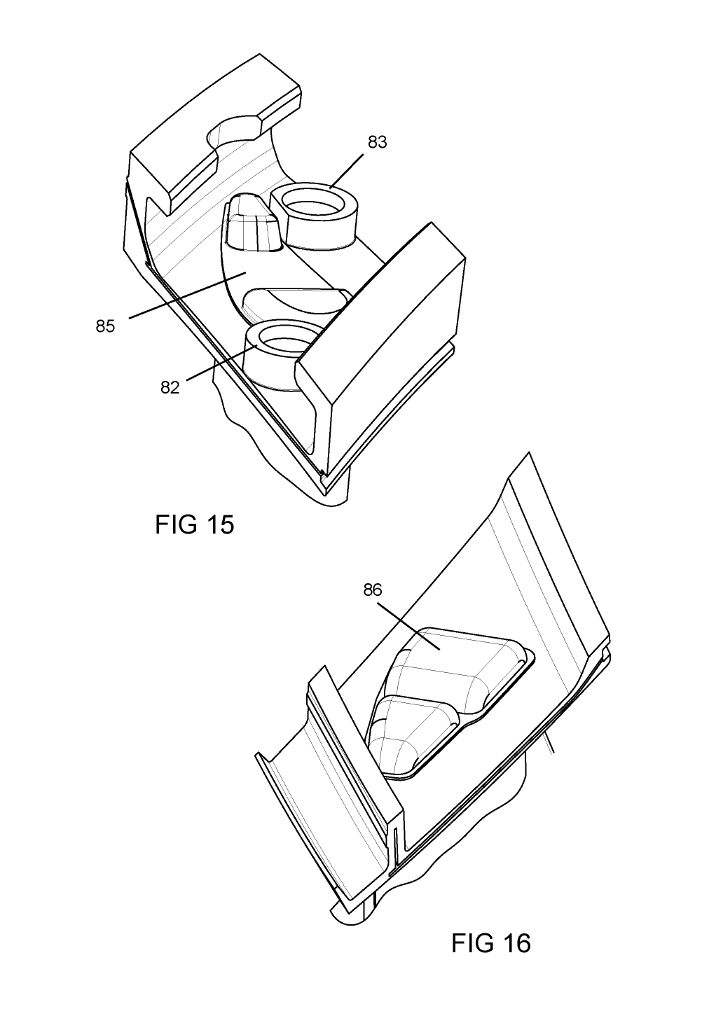

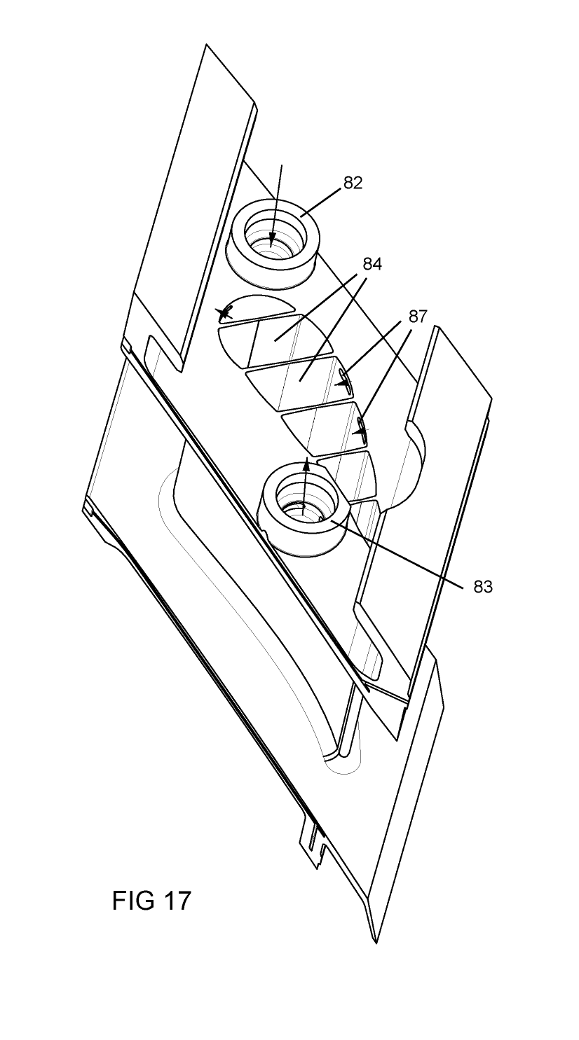

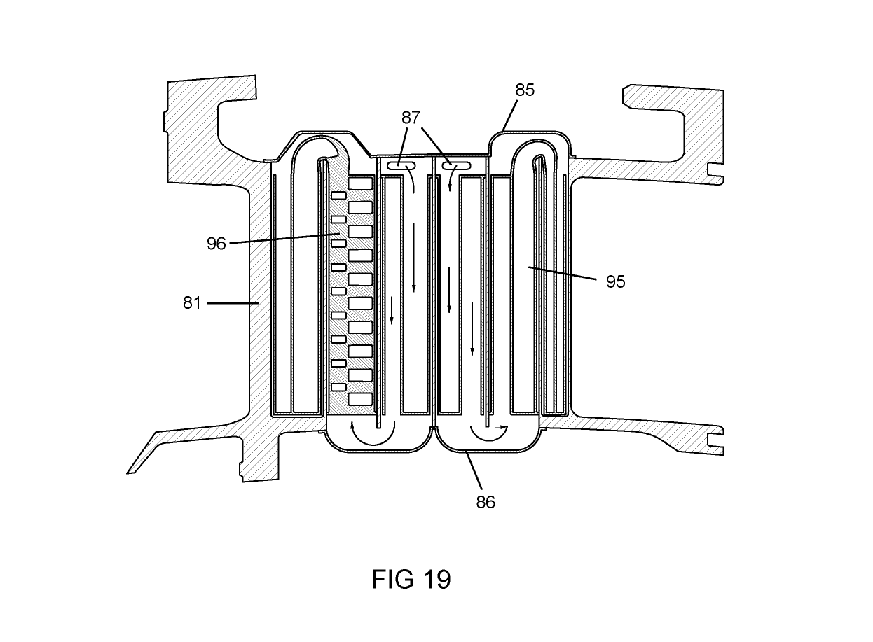

FIG. 15 shows a top side of the vane with the cooling air inlet 82 and a cooling air outlet 83 and an outer diameter (OD) cover plate 85 that encloses the upper section of the vane cooling circuit with the two turn channels 93 and 94. FIG. 16 shows a bottom side of the vane with inner diameter (ID) cover plate 86 that encloses the bottom section of the vane cooling circuit and forms the turn channels for the cooling air in the two inserts. FIG. 19 shows a side view of the vane with the two inserts and the OD and ID cover plates 85 and 86 with the cooling flow directions.

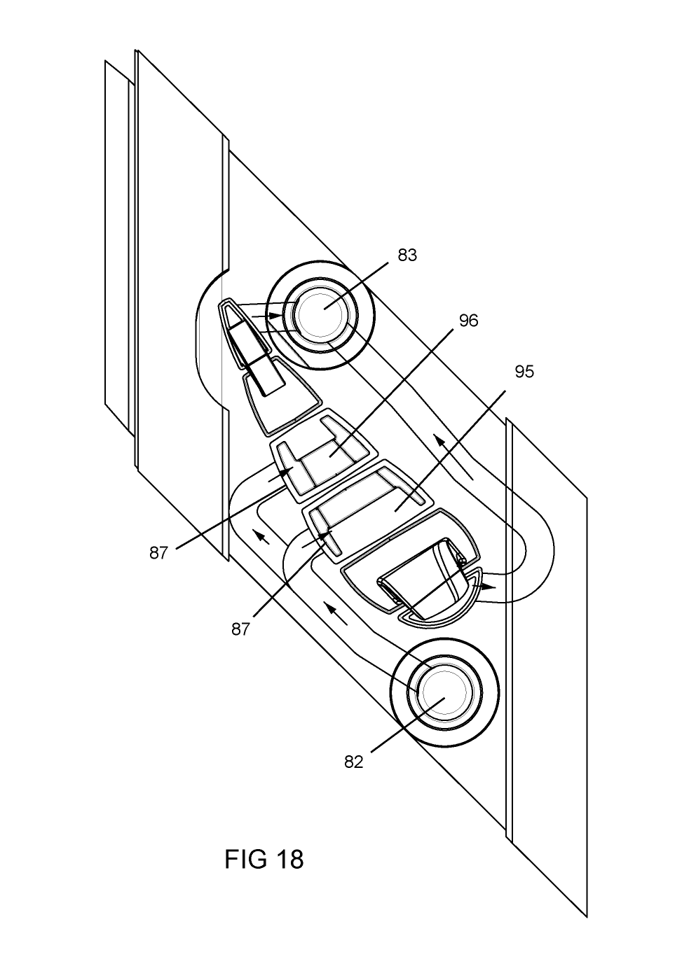

FIG. 17 shows the vane without the two inserts. The cooling air inlet 82 and a cooling air outlet 83 is shown, and the number of internal cooling air passages 84 in which the two inserts would fit. A number of cooling air feed passages 87 are shown in which cooling air is delivered to the two inserts or from the two inserts. FIG. 18 shows a top view of the vane and the two inserts and the flow directions of the cooling air to and from the inserts. Cooling air flows into the inlet 82 and then along a channel in the outer diameter endwall and into the feed passages 87 that open into the forward and aft inserts 95 and 96. The cooling air then flows through each insert through the rows of impingement holes 91 and return openings 92 to cool each wall of the airfoil, and then flows out from each insert and along channels in the outer endwall and into the outlet 83. From the cooling air inlet 82 to the cooling air outlet 83, the cooling air passes through the inserts and the airfoil in a closed loop cooling circuit in which none of the cooling air is discharged out from the airfoil and into the hot gas stream passing around the vane.

FIG. 19 shows a side view of the two inserts 95 and 96 within the vane airfoil 81 with the outer and inner cover plates 85 and 86 and the cooling air feed passages 87.

I claim the following:

1: A turbine stator vane with a closed loop cooling circuit comprising:
an airfoil extending between an outer endwall and an inner endwall;
the outer endwall having a cooling air inlet and a cooling air outlet;
the airfoil having a plurality of internal cooling air passages that each opens into the outer endwall and the inner endwall;
each of the plurality of internal cooling air passages extending from a pressure side wall to a suction side wall of the airfoil;
an impingement cooling insert secured within the plurality of internal cooling air passages to provide impingement cooling to the pressure side wall and the suction side wall of the airfoil;
the impingement cooling insert having a plurality of spanwise extending cooling air supply channels and a plurality of spanwise extending cooling air return channels;
the impingement cooling insert having a plurality of chordwise extending impingement surfaces alternating with a plurality of chordwise extending cooling air return slots;
the plurality of chordwise extending impingement surfaces each having a row of impingement holes connected to a spanwise extending cooling air supply channel;
the plurality of chordwise extending cooling air return slots each having a cooling air return opening connected to a spanwise extending cooling air supply channel; and,
a cooling air flow in the spanwise extending cooling air supply channel is in the same direction as the cooling air flow in the spanwise extending cooling air return channel.

2: The turbine stator vane of claim 1, and further comprising:
the impingement cooling insert extends a spanwise length of the airfoil.

3: The turbine stator vane of claim 1, and further comprising:
the impingement cooling insert includes a first spanwise extending cooling air supply channel and a first spanwise extending cooling air return channel in which cooling air flows from the outer endwall to the inner endwall direction;
the impingement cooling insert includes a second spanwise extending cooling air supply channel and a second spanwise extending cooling air return channel in which cooling air flows from the inner endwall to the outer endwall direction; and,
a coolant turn passage connecting the first spanwise extending supply and return channels to the second spanwise extending supply and return channels.

4: The turbine stator vane of claim 1, and further comprising:
the impingement cooling insert includes a leading edge insert and a trailing edge insert that form separate impingement cooling circuits within the airfoil.

5: The turbine stator vane of claim 1, and further comprising:
the impingement cooling insert includes a first cooling air supply channel and a first cooling air return channel, a second cooling air supply channel and a second cooling air return channel, and a third cooling air supply channel and a third cooling air return channel;
an inner endwall turn channel connected between the first supply and return channels and the second supply and return channels;
an outer endwall turn channel connected between the second supply and return channels and the third supply and return channels; and,
the first and second and third supply and return channels form a three-pass serpentine flow circuit within the airfoil.

6: The turbine stator vane of claim 5, and further comprising:
the third cooling air supply and return channels are located in a leading edge region of the airfoil.

7: The turbine stator vane of claim 5, and further comprising:
the third cooling air supply and return channels are located in a trailing edge region of the airfoil.

8: The turbine stator vane of claim 5, and further comprising:
the first spanwise extending cooling air supply channel is connected to the cooling air inlet through a supply channel formed in the outer endwall; and,
the third cooling air return channel is connected to the cooling air outlet through a return channel formed in the outer endwall.

9: The turbine stator vane of claim 5, and further comprising:
an outer diameter cover plate forms an outer diameter turn channel; and,
an inner diameter cover plate forms an inner diameter turn channel.

10: The turbine stator vane of claim 1, and further comprising:
the airfoil has no film cooling holes that discharge cooling air into a hot gas stream passing around the airfoil.

11: An impingement cooling insert for a closed loop cooling circuit with a stator vane airfoil comprising:
a leading edge insert and a trailing edge insert;
both of the leading edge insert and the trailing edge insert having a first cooling air supply channel and a first cooling air return channel, a second cooling air supply channel and a second cooling air return channel, and a third cooling air supply channel and a third cooling air return channel connected in series to form a three-pass serpentine flow cooling circuit;
both of the leading edge insert and the trailing edge insert having an inner diameter turn channel between the first and second supply and return channels;
both of the leading edge insert and the trailing edge insert having an outer diameter turn channel between the second and third supply and return channels;
each of the cooling air supply channels having a plurality of chordwise extending rows of impingement cooling air holes on a pressure side and a suction side of the insert;
each of the cooling air return channels having a plurality of cooling air return openings on the pressure side and the suction side of the insert; and,
cooling air from the supply channel flows through the rows of impingement cooling holes, and then through the cooling air return openings and into the cooling air return channel.

12: The impingement cooling insert of claim 11, and further comprising:
the impingement cooling holes are formed in outward extending projections of the insert that alternate between slots in which the return openings are located.

13: The impingement cooling insert of claim 11, and further comprising:
a cooling air flow direction in the cooling air supply channel is the same direction in the cooling air return channel in each insert.
